(19) United States
(12) Patent Application Publication
(10) Pub. No.: US 2007/0285358 A1
(43) Pub. Date: Dec. 13, 2007

(54) Active matrix display element and device

(75) Inventors: Toshihiro Nishioka, Chiba (JP); Akihiro Nonaka, Chiba (JP)

Correspondence Address: BACON & THOMAS, PLLC, 625 SLATERS LANE, FOURTH FLOOR, ALEXANDRIA, VA, 22314, US

(73) Assignee: Futaba Corporation, Chiba (JP)

(21) Appl. No.: 11/806,288

(22) Filed: May 31, 2007

(30) Foreign Application Priority Data
Jun. 9, 2006 (JP) 2006-160943

(51) Int. Cl. G09G 3/22

(52) U.S. Cl. 345/75.1

(57) ABSTRACT

An active matrix display device includes a CPU; a glass substrate; and a display panel unit formed on the glass substrate, the display panel unit including a control unit and a display section together. The display panel unit is provided with a data input terminal, a clock terminal and a data latch terminal, which are connected to the CPU, a test terminal to which a test signal from the CPU is inputted, and a data output terminal for outputting data written to the display section upon input of the test signal. The display panel unit may be further provided with a write enable terminal for receiving a write control signal; and a blank terminal for adjusting brightness of the display section.

### FIELD OF THE INVENTION

The present invention relates to an active matrix display element and device.

### BACKGROUND OF THE INVENTION

Recently, there have been widely used flat panel display devices, such as a liquid crystal monitor, a plasma display, an electroluminescent display (ELD), a light emitting diode (LED), a vacuum fluorescent display (VFD), a field emitting display (FED) and the like. Among them, the VFD, the ELD, the LED and the FED belong to self-luminous display devices and, furthermore, enable high resolution.

The VFD includes a directly heated cathode electrode, referred to as a filament, in a vacuum vessel (envelope) having at least one transparent side. The VFD is an electron tube, wherein thermal electrons emitted from the directly heated cathode electrode collide with fluorescent substance coated on an anode electrode in a display pattern, thereby displaying a desired pattern.

As one of such VFDs, there is an active matrix VFD including a luminous display surface obtained by arranging semiconductor chips on an insulating substrate, wherein the semiconductor chip has a luminous display section in which a plurality of anodes coated with a fluorescent substance are arranged in a matrix pattern and a drive circuit for controlling luminescence of the luminous display section integrally formed therewith.

An active matrix VFD disclosed in Japanese Patent Laid-open Application No. S56-24993 (Patent Reference 1) has an anode substrate obtained by integrating a MOS switching array on a silicon monocrystalline substrate and coating fluorescent substances thereon.

The active matrix VFD provides high resolution, high brightness and high reliability, since it is a self-luminous element. Accordingly, the active matrix VFD has been widely used as head-up display devices for displaying informations for a driver in a car, for example. Therefore, there has been developed an active matrix VFD capable of achieving a large display area and a high pixel density with a relatively low cost.

In Japanese Patent Laid-open Application No. 2002-8571 (Patent Reference 2), there is disclosed a fluorescent display apparatus including an anode substrate where a luminous display section having a plurality of anodes coated with a fluorescent substance and arranged in a matrix pattern and a drive circuit for controlling luminescence of the luminous display section are integrally formed; a cathode disposed to face a mounting surface of the anode substrate on which the luminous display section is mounted; and a vacuum envelope enclosing the anode substrate and the cathode and having one transparent side. Then, the anode substrate includes a glass substrate, a silicon film formed on the glass substrate and an insulating film formed on the silicon film. The luminous display section is formed on the insulating film and the drive circuit is formed in the silicon film, so as to be connected to anode electrodes via through-holes formed in the insulating film. In this way, the fluorescent display apparatus is intended to achieve a large display area and a high pixel density with a relatively low cost.

The present inventors have developed an active matrix drive display element disclosed in Japanese Patent Laid-Open Application No. 2003-106284 (Patent Reference 3), in order to achieve a large display area and a high pixel density with a relatively low cost.

In the active matrix VFD disclosed in Patent Reference 3, as illustrated in FIG. 2B, FIG. 3 and FIG. 4, a control IC 131 is mounted on a substrate 110 separately from a display panel IC 130, so that control signals of the control IC 131 is transmitted to column/row signal lines of the display panel IC 130 through aluminum wiring lines 136 and fine lines for wire bonding 135, thereby actuating a display section 132 of the display panel.

Data signals from a CPU 140 to the control unit 131 are outputted serially and data signals from the control unit 131 to the display panel IC 130 are outputted parallel. Therefore, the connection of the control IC 131 with the display panel IC 130 through the fine lines for wire bonding 135 requires processes corresponding to the number of the column and row wiring lines, which becomes a hindrance in achieving a large display area and a high pixel density with a relatively low cost.

Further, a display status of the display panel is inspected only with the naked eyes, after completing manufacture of the active matrix VFD.

That is, the outputs of the control unit are parallelly connected to the display panel, since the signals from the control unit are parallelly inputted to the display panel. Column and row signal outputs from the control unit are transmitted to column and row wiring lines through the wire bonding, so that the output lines of the control unit serve as the input lines of the display section. For this reason, the control unit is unable to read outputs of latch data written to the display panel, so that it is impossible to inspect the outputs of the latch data written to the display panel by the control unit reading the outputs of the latch data.

### SUMMARY OF THE INVENTION

It is, therefore, an object of the present invention to provide an active matrix display device capable of achieving a high reliability, a small area and a low cost wherein the number of fine lines for wire bonding is reduced and an IC inspection is feasible by mounting a display circuit unit and a control circuit unit on a single IC, compared with a conventional case where a display circuit unit IC and a control circuit IC are separately mounted on a same substrate so that control signals of the control circuit IC are parallelly transmitted to column/row signal lines of the display circuit unit IC by wire bonding.

In accordance with an aspect of the present invention, there is provided an active matrix display element including a glass substrate; and a display panel unit formed on the glass substrate, the display panel unit including a control unit and a display section together, wherein the display panel unit is provided with a data input terminal; a clock terminal; a data latch terminal; a test terminal to which a test signal is inputted; and a data output terminal for outputting data written to the display section upon input of the test signal.

The display panel unit may be further provided with a write enable terminal for receiving a write control signal; and a blank terminal for adjusting brightness of the display section.

It is preferable that the display panel unit is an active matrix vacuum fluorescent display.

In accordance with another aspect of the present invention, there is provided an active matrix display device including a CPU; a glass substrate; and a display panel unit formed on the glass substrate, the display panel unit including a control unit and a display section together, wherein the display panel unit is provided with a data input terminal, a clock terminal and a data latch terminal, which are connected to the CPU, a test terminal to which a test signal from the CPU is inputted, and a data output terminal for outputting data written to the display section upon input of the test signal.

In accordance with the present invention, the display section and the control unit are mounted together on a single IC, so that a ratio of the display area per an area of the glass substrate can be increased and to make the total inspection of the product easy. Mounting the display section and the control unit on a single IC reduces the number of fine lines for wire bonding used for parallel connections and makes it easy to inspect the IC for enhancing reliability of AMVFD. Thus, the configuration of the system can be simplified to achieve an enhanced reliability, an area reduction and a low cost.

Further, in accordance with the present invention, the number of the fine lines for wire bonding can be reduced by mounting the control unit IC in the display panel unit to thereby reduce a dead space of a non-display section. Thus, it is possible to make the width of the glass substrate reduced by about 3 mm, which is typically needed to connect the control unit with the display section by wire bonding, and also make the time required to mount them shortened, thereby achieving a high reliability, a small area and a low cost.

Further, since a function of conventional serial-in-parallel-out driver can be provided to a panel driver of the display panel unit, it is possible to test the IC as well as to reduce the cost thereof.

### BRIEF DESCRIPTION OF THE DRAWINGS

The above and other objects and features of the present invention will become apparent from the following description of embodiments, given in conjunction with the accompanying drawings, in which:

FIG. 1 shows a circuit diagram of a vacuum fluorescent display in accordance with the present invention;

FIG. 2 describes a comparison of the vacuum fluorescent display of the present invention with a conventional vacuum fluorescent display;

FIG. 3 illustrates a diagram of an active matrix drive circuit of the present invention; and

FIG. 4 shows a circuit diagram of the conventional vacuum fluorescent display.

### DETAILED DESCRIPTION OF THE EMBODIMENTS

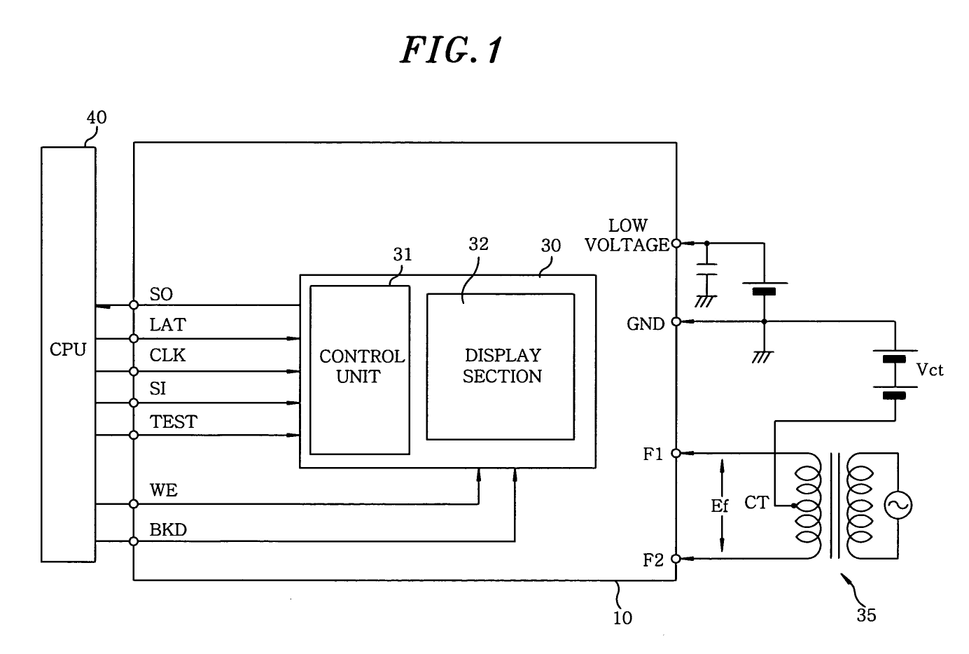

Hereinafter, a display apparatus using an active matrix vacuum fluorescent display (AMVFD) in accordance with an embodiment of the present invention will be described with reference to FIGS. 1 to 3.

The AMVFD includes a glass vessel 39 that is a sealed vessel having a glass substrate 10 as a bottom part, an active matrix IC 30 that is an IC chip formed on the glass substrate 10 in the glass vessel 30 and a filament 38. The AMVFD is connected to a CPU 40, a power supply Vct and a filament power supply 35 via leads (not shown).

The active matrix IC 30 includes a display section 32 having a display element and a display circuit for driving the display element and a non-display section 33. A control unit 31 is formed in the non-display section 33.

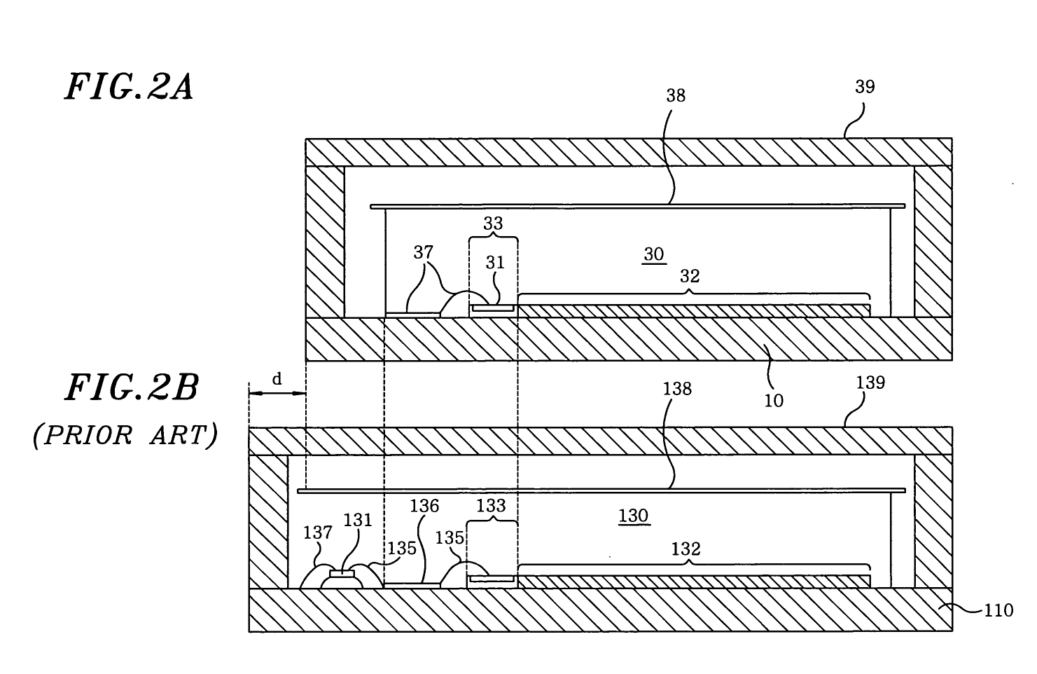

As illustrated in FIG. 2A, the non-display section 33 is located near a connection area of the filament 38 where temperature of the filament 38 is low, so that the non-display section 33 cannot be used as a display section. Therefore, a peripheral circuit and the like are provided in the non-display section 33 and, in this embodiment, the control unit 31 is provided as an IC in the non-display section 33.

The CPU 40 is connected to input terminals of the control unit 31, such as a latch input terminal LAT, a shift register clock terminal CLK, a serial data input terminal SI, a serial output terminal SO and a test terminal TEST. Further, the CPU 40 is connected to a write enable terminal WE and a blank terminal BKD for adjusting brightness of the display section 32.

A data signal from the CPU 40 is outputted serially to the control unit 31. The control unit 31 applies serial/parallel conversion to the data signal through a CLK signal and a LAT signal, to thereby output the data signal to the display section 32 through a WE signal and a BKD signal (and also the LAT signal, if desired).

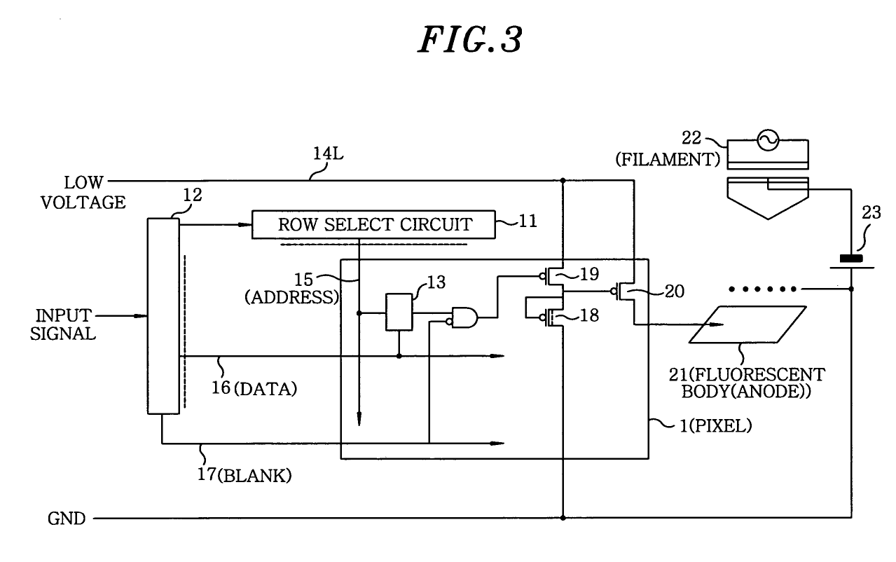

An active matrix drive circuit of FIG. 3 includes the control unit 31 and the display section 32 together, wherein the control unit 31 has a circuit 11 for selecting rows of display pixels and a logic control circuit 12 and the display section 32 has a holding unit 13 and drive circuits 18 and 19 for driving an anode electrode provided to each display pixel, a drive output circuit 20 of a display pixel unit 21, an address signal line 15, a data signal line 16 and the like. FIG. 3 shows only the active matrix drive circuit for a single pixel.

An input signal includes a row address select signal, a logic control signal and a display data signal. In response to the row address select signal, one row of the address signal line 15 is selected by a decoder. The display data signal inputs data to each column.

In response to the row address select signal and display data signal, data for each pixel arranged in a matrix pattern are held in the holding unit 13 of the selected row, which is data for one row, and sequential increment of the row address select signal is repeated until data for all the rows are written.

Data outputted by a logical product of the held data and a blank signal are inputted to the drive output circuit 20 at the final stage of the display pixel unit 21 via the drive circuits 18 and 19 to be display data.

The drive circuits 18 and 19 are respectively formed of a depletion mode P channel MOSFET 18 and an enhancement mode P channel MOSFET 19. The drive output circuit 20 at the final stage is formed of a P channel MOSFET 20. Further, the P channel MOSFET 20 is a high withstand voltage P channel MOSFET. Further, the depletion mode MOSFET 18 may be replaced with an enhancement mode N channel MOSFET.

The drive output circuit 20 at the final stage is formed of the P channel MOSFET and, in driving the anode electrode, a signal level voltage superposed to a filament center tap voltage is applied to the anode electrode, so that the signal level voltage from the drive output circuit becomes low. Therefore, no transistor for high withstand voltage is required, except for the transistor at the final stage.

Since the configuration includes the P channel MOSFET structures only, a low voltage power supply and a GND are sufficient for each display pixel.

From the above, since it is sufficient that only one high withstand voltage transistor, whose design rule is strict, is disposed in each pixel, consumption current can be suppressed to be small. The size of the pixel can also be reduced, since it is sufficient to provide only two power supply lines, a low voltage line and a GND line. Accordingly, the holding circuit, drive circuit and drive output circuit can be arranged under an anode electrode forming a pixel of the drive output unit. Further, the pitch between pixels can be narrowed, which makes it possible to obtain a high resolution display.

As described above, the control unit 31 of the VFD of the present invention includes a shift register circuit for performing the serial/parallel conversion by taking a conventional serial driver input manner for CIG (chip in glass).

Serial data are inputted in synchronization with a CLK signal from the CPU 40. LAT is a signal for transferring data to the display section.

A WE signal and a BKD signal are inputted directly to the display section 32. The WE signal is a data write control signal and the BKD signal is a signal for adjusting brightness of the display section.

In this embodiment, as illustrated in FIG. 2A as a sectional view, the AMVFD includes, on the glass substrate 10, the display section 32 of the active matrix IC 30, the control unit 31 provided in the non-display section 33 and a wire bonding unit 37 connected with the control unit 31. Although not shown, the non-display section 33 unsuitable for displaying is also present at the right side in FIGS. 1 and 2.

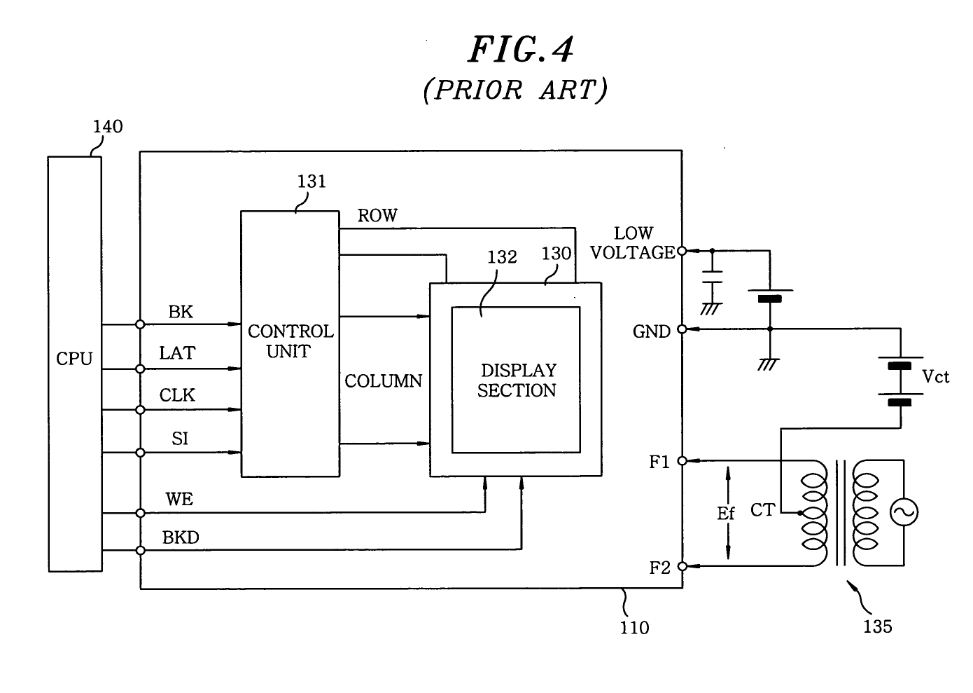

FIG. 2B illustrates a sectional view of a conventional AMVFD shown in FIG. 4. The AMVFD includes, on a glass substrate 110, an active matrix IC 130 having a display section 132 and a non-display section 133, fine lines for wire bonding 135 for connection with a display panel 130, a control unit 131 connected to aluminum lines 136, and fine lines for wire bonding 137 connected to a CPU 140 (not shown in FIG. 2B).

Difference “d” in width between the AMVFDs shown in FIGS. 2A and 2B indicates the reduced size of the AMVFD in accordance with the present invention. In accordance with the present invention, the AMVFD can be made to have a substrate of a width reduced by the difference “d” compared with the conventional AMVFD having the same area as that of the AMVFD of the present invention, so that a ratio of the display area per an area of the glass substrate can be increased.

Further, in accordance with the present invention, the TEST terminal and the SO terminal are provided as input and output terminals of the active matrix IC 30, respectively, so that the AMVFD can be tested.

When the TEST terminal becomes ‘H’ in response to a signal from the CPU 40, a test mode is set. In response to a row address select signal inputted from the SI terminal, latch data written to the selected row of the display section are outputted from the SO terminal, so that the active matrix IC 30 can be tested.

In accordance with the present invention, compared with a conventional case where a control IC and a separate display IC are mounted on a substrate and the control signals of the control IC are transmitted to column/row signal lines of the display IC in parallel by wire bonding, the display section and the control unit are provided on a single IC, so that the IC test can be carried out and the wire bonding of parallel connections can be omitted. Accordingly, as for the IC of the display section 32 of the active matrix IC 30, yield of products is considerably increased, thereby achieving an enhanced reliability, an area reduction and a low cost.

The test of the active matrix IC by using the SO terminal can make the tests of AMVFD products easy, to thereby improve accuracy thereof.

The SO terminal makes cascade connections of data possible in a normal mode, and makes it possible to read latched data written to each pixel in a test mode. Therefore, the SO terminal can be used for data cascade.

The AMVFD of the present invention, configured as described above, includes the active matrix substrate including the display section 32 and the control unit 31 together. Then, a data signal from the CPU 40 to the active matrix IC 30 is outputted serially through the SI terminal, thereby making it possible to reduce the number of input and output terminals considerably.

In accordance with the present invention, by integrating the control unit 31 and the display section 32 in the active matrix IC 30, a BK terminal which is adapted to control an output of the control unit 131 by the CPU 140 in the conventional example is not required and can be omitted.

While the invention has been shown and described with respect to the embodiments, it will be understood by those skilled in the art that various changes and modifications may be without departing from the scope of the invention as defined in the following claims.

What is claimed is:

1. An active matrix display element comprising:
a glass substrate; and
a display panel unit formed on the glass substrate, the display panel unit including a control unit and a display section together,
wherein the display panel unit is provided with a data input terminal; a clock terminal; a data latch terminal; a test terminal to which a test signal is inputted; and a data output terminal for outputting data written to the display section upon input of the test signal.

2. The active matrix display element of claim 1, wherein the display panel unit is further provided with a write enable terminal for receiving a write control signal; and a blank terminal for adjusting brightness of the display section.

3. The active matrix display element of claim 2, wherein the display panel unit is an active matrix vacuum fluorescent display.

4. An active matrix display device comprising:
a CPU;
a glass substrate; and
a display panel unit formed on the glass substrate, the display panel unit including a control unit and a display section together,
wherein the display panel unit is provided with a data input terminal, a clock terminal and a data latch terminal, which are connected to the CPU, a test terminal to which a test signal from the CPU is inputted, and a data output terminal for outputting data written to the display section upon input of the test signal.
